(19) United States
(12) Patent Application Publication
(10) Pub. No.: US 2009/0265042 A1
(43) Pub. Date: Oct. 22, 2009

(54) System and Method for Providing Voltage Regulation in a Power Distribution System

(76) Inventors: James D. Mollenkopf, Fairfax, VA (US); Brian J. Deaver, SR., Fallston, MD (US); Joseph B. Herron, JR., Washington, DC (US); David G. Kreiss, San Diego, CA (US)

Correspondence Address: CAPITAL LEGAL GROUP, LLC, 1100 River Bay Road, Annapolis, MD, 21409, US

(21) Appl. No.: 12/424,322

(22) Filed: Apr. 15, 2009

Related U.S. Application Data
(60) Provisional application No. 61/045,851, filed on Apr. 17, 2008.

(51) Int. Cl. G06F 1/26; H02J 3/00

(52) U.S. Cl. 700/298; 307/31

(57) ABSTRACT

A system and method of regulating the voltage of the power supplied to a plurality of power customers via a power distribution system that includes low voltage power lines and medium voltage power lines is provided. In one embodiment, the method includes measuring the voltage of a plurality of low voltage power lines at a plurality locations in the power distribution system with a plurality of voltage monitoring devices; with the plurality of voltage monitoring devices, transmitting voltage data in real time to a remote computer system; receiving, with the computer system, the real time voltage data of the voltage measured from the voltage monitoring devices; comparing, with the computer system, the real time voltage data with a first threshold value; and if the real time voltage data is beyond the first threshold value, transmitting with the computer system a first voltage adjustment instruction to a voltage control device configured to adjust the voltage supplied to a low voltage power line.

### CROSS REFERENCE TO RELATED APPLICATIONS

This application claims priority to U.S. Patent Application No. 61/045,851, filed Apr. 17, 2008, which is hereby incorporated herein by reference in its entirety for all purposes.

### FIELD OF THE INVENTION

The present invention generally relates to the operating a power distribution system and more particularly, to a system and method for operating a power distribution system to regulate the voltage supplied to a plurality of customer premises by the power distribution system.

### BACKGROUND OF THE INVENTION

The economic and environmental cost of generating and distributing power to power customers is enormous. Even a small percentage reduction in power consumption translates to an enormous financial savings and reduced emissions.

FIG. 1 illustrates a conventional power grid 100. Power is conducted from the substation 14 to one or more distribution transformers 60 over one or more medium voltage (MV) power lines 20. Power is conducted from the distribution transformer 60 to the customer premises 40 via one or more low voltage (LV) power lines 114 (typically carrying 120-240 volts in the US). Customer premises 40 include a low voltage premises network 55 that provides power to individual power outlets within the customer premises 40.

While FIG. 1 depicts only a single customer premises 40, in practice MV power lines 110 extend for considerable distances and provide power to numerous residential and business customers. The voltage supplied to those power customers that are farthest from the substation may be considerably less than the voltage supplied to power customers that are near the substation because of losses caused by the power distribution system. During power distribution, the voltage supplied to the medium voltage power line 110 by the substation 14 must be maintained so that the voltage at all the customer premises satisfies regulatory requirements. Utilities typically must make an educated “guess” as to the voltage required to be supplied by the substation 14 based on an estimated voltage drop to the power customers receiving the lowest voltages. The voltage supplied by the substation is regulated (i.e., controlled) according to this estimated voltage drop.

In addition, an engineering margin must be added to the estimated voltage to be delivered to the power customers due to the uncertainty of the losses of various components of the power grid 100 such as, for example, transformer losses and power line losses. Thus, a voltage provided by a substation 14 may be regulated based on an educated “guess” of the voltage drop plus an added voltage to provide a margin of error. Regulating a voltage based on an educated “guess” and a margin of error often results in the utility providing a voltage that is higher than required by regulatory requirements, which in some instances causes a greater than necessary delivery of power. Currently, there is no cost efficient means for an electric utility to accurately determine the precise voltage to be supplied by a substation 14 to provide a desired voltage at a customer premises. These and other advantages are provided by various embodiments of the present invention.

### SUMMARY OF THE INVENTION

The present invention provides a system and method of regulating the voltage of the power supplied to a plurality of power customers via a power distribution system that includes low voltage power lines and medium voltage power lines. In one embodiment, the method includes measuring the voltage of a plurality of low voltage power lines at a plurality locations in the power distribution system with a plurality of voltage monitoring devices; with the plurality of voltage monitoring devices, transmitting voltage data in real time to a remote computer system; receiving, with the computer system, the real time voltage data of the voltage measured from the voltage monitoring devices; comparing, with the computer system, the real time voltage data with a first threshold value; and if the real time voltage data is beyond the first threshold value, transmitting with the computer system a first voltage adjustment instruction to a voltage control device configured to adjust the voltage supplied to a low voltage power line.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 depicts a conventional power distribution system.

FIG. 2 is a diagram of a power distribution system incorporating a Monitoring System (MS), in accordance with an example embodiment of the present invention.

FIG. 3 depicts Monitoring System (MS), in accordance with an example embodiment of the present invention.

FIG. 4 depicts a voltage monitor (VM), in accordance with an example embodiment of the present invention.

FIG. 5 depicts a method of using a voltage monitor, in accordance with an example embodiment of the present invention.

FIG. 6 depicts a method of using a computer system to control the voltage supplied to one or more customer premises, in accordance with an example embodiment of the present invention.

FIG. 7 depicts a schematic of an example of a power line communication system.

FIG. 8 is a block diagram of an example embodiment of a backhaul node for use in example embodiments of the present invention.

FIG. 9 illustrates an implementation of an example embodiment of a backhaul node for use in example embodiments of the present invention.

FIG. 10 is a block diagram of an example embodiment of an access node for use in example embodiments of the present invention.

FIG. 11 illustrates an implementation of an example embodiment of an access node for use in example embodiments of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description.

In accordance with the principles disclosed herein, a system for performing Conservation Voltage Reduction (CVR)—or otherwise providing voltage control—with real time data is disclosed. In particular, a system for controlling delivered voltage (CDV) is disclosed that uses real time voltage data from elements of a power grid 100 that may include a substation 14, one or more customer premises 40, and/or one or more other power distribution parameter monitoring devices.

Various embodiments of the present invention provide a system and method of determining voltage and current data for a power distribution system 100. The data may be collected by a Monitoring System (MS) 150 and used to determine a new voltage, which may include adjusting the voltage supplied by the substation 14, redirecting the flow of power flow, increasing or decreasing a capacitance, etc. For example, the command may be sent to a substation (e.g., to increase or decrease the voltage), a capacitor bank (e.g., to switch in or switch out one or more capacitors), a voltage regulator or other distribution equipment in order to cause the automated equipment to take action, which directly (or indirectly) effects the voltage somewhere in the distribution system.

In one example embodiment, the voltage information from all of the measuring (i.e., monitoring) devices is periodically received in substantially real time by a remote computer for processing. That remote computer includes the software application configured to calculate control commands to be sent to equipment at the substation(s) and/or elsewhere (e.g., capacitor banks, volt regulators, switches, reclosers, voltage regulator) in the power distribution system to adjust the voltage throughout a feeder (i.e., an MV power line) or set of feeders so that power consumption can be minimized while ensuring the voltage delivered to customers maintains required voltage levels. The software application continuously monitors the voltage being supplied to the power customers to ensure that the voltage supplied to each customer is just slightly above the minimum required voltage. If data is received that indicates a voltage is too low (below the minimum voltage required) or too high (some quantity (e.g., percentage or value) above the maximum voltage), the application will cause control commands to be sent to one or more pieces of equipment causing them to take action to thereby adjust the voltage as necessary. For example, the command may be sent to a substation (e.g., to increase or decrease the voltage), a capacitor bank (e.g., in switch in or out one or more capacitors), a voltage regulator or other distribution equipment in order to cause the automated equipment to take action, which directly (or indirectly) effects the voltage somewhere in the distribution system. Additionally, a message can be sent to the utility personnel who can operate equipment to adjust the voltage.

Prior to the present invention, it was common for the utilities to estimate the voltage to be supplied from the substation to deliver the minimum required voltage to any customer. Because this has been an estimate, the utilities have had to base their estimates on a worst case scenario (e.g., worst line losses, worst transformer losses, etc.) to compute the estimate. Additionally, recognizing that the computed voltage is an estimate, the utilities have had to consider a margin of error and add some additional voltage. As a result, in practice utilities consistently have been supplying a greater voltage than necessary from the substations to the power distribution networks resulting in greater than necessary line losses (MV and LV), transformer losses, infrastructure losses, infrastructure equipment failures, and (in some cases) unnecessarily increased utility fees to customers. This has further resulted in an increased and unnecessary production of green house gases (carbon emissions).

In various embodiments, factors included in the improved efficiency provided by the present invention may include the voltage at some or all of the sensors and/or meters, voltage(s) at the substation, the environmental and cost mix of power generation, emissions taxes, the impact on (and of) line losses and the types of loads (e.g., inductive) on the electric grid. In one example, the cost of power generation may determine when to invoke an efficiency improvement or otherwise impact the voltage or power factor thresholds to which the software requires the system satisfy.

One implementation uses the sensors to monitor the voltage at all of the sensors or endpoints (meters) on a feeder and having those sensors and endpoints communicate alerts when the voltage falls outside a specified range. The voltage at the point of supply to the feeder(s) (e.g., at the substation) may then be adjusted until an out of range alert (e.g., too low a voltage) is received from one of the sensors. In addition or alternately, sensors may be positioned at communication devices co-located with distribution transformers that transmit the alerts and/or voltage data. When an alert is received, the voltage may be adjusted upward slightly to the previous voltage and/or until a subsequent within limits notification is received.

The voltage can be continually adjusted (e.g., as the load changes) to ensure that the voltage remains within specified limits at all delivery points connected to the feeder. The system will monitor the voltage and other factors on a predetermined time period basis which will usually be hourly or less and will automatically determine the adjustments necessary to achieve the desired improvement, which adjustments may be automatically implemented by communicating electronically to the substation and/or other utility devices.

The system may also determine areas of each feeder that are performing differently than the others (e.g., one area of a feeder or LV subnet is always lower (or higher) than others) allowing for existing remediation techniques (e.g., utility can be notified to install a capacitor bank, or to change the feeder's configuration to be able to reduce or increase the voltage to the entire feeder) to be used to correct the performance of those areas so overall savings can be maximized or improved.

The impact of this system allows among other things, the power system to operate at lower voltages (and/or at a power factor closer to one throughout) in order to reduce carbon emissions from electric power.

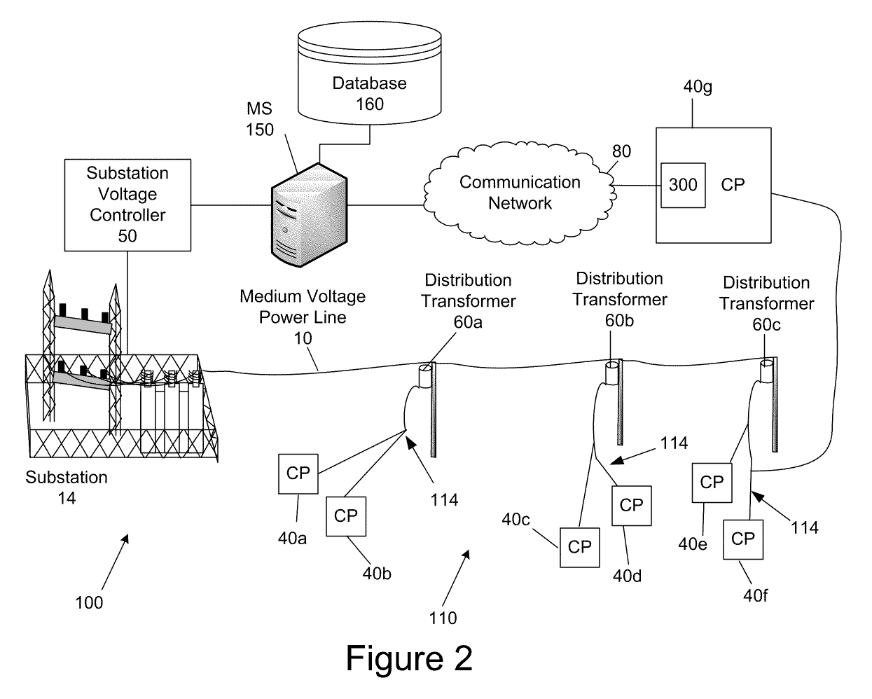

Various embodiments of the present invention provide a system and method of monitoring the voltage delivered to one or more customer premises 40 and for using real time voltage measurement data to adjust the voltage supplied to the portion of the power grid that provides power to that customer premises. Referring to FIG. 2, a Voltage Monitor (VM) 300 may be integrated into an electric power meter and monitor the AC voltage delivered to the customer premises 40. The VM 300 may send an indication of the voltage monitored to a remote Monitoring System (MS) 150.

For example, the VM 300 may formulate a data packet with the measured voltage data for transmission to the MS 150. The MS 150 receives the voltage data (e.g., in real-time) measured at the electrical meter at a customer premises 40, and may use the data to control a voltage supplied to the power grid by the substation 14 and/or to control other utility equipment.

In accordance with the principles disclosed herein, the VM 300 allows a utility to accurately determine the voltage at one or more customer premises 40. Through the monitoring of the voltage at one or more customer premises 40, typically at locations experiencing the greatest voltage drops across the power grid, a utility may accurately adjust the voltage supplied to a medium voltage power line 110 in real-time to satisfy a regulatory minimum and maximum voltages. Calculating the voltage to be supplied by the substation 14 eliminates the likelihood that the utility will provide a voltage to the customer premises 40 that is too high (or too low). This in turn may reduce the power requirements of the power generation source. Even a small reduction in power across a power grid can aggregate to enormous cost and environmental savings.

Referring to FIG. 2, substation load tap changer controller 50 controls the voltage supplied to medium voltage (MV) power line 110 by the substation 14. In this embodiment, the substation load tap changer voltage controller 50 may receive voltage instructions from MS 150. In other embodiments, other devices may be used to control the voltage supplied by the substation.

The MS 150 may send voltage instructions to the substation load tap changer voltage controller 50 to adjust the voltage supplied to the medium voltage power line 110 by substation 14. The MS 150 may store various types of parameters that serve as a basis from which to formulate and send instructions to the substation voltage controller 50. The MS 150 may store the various types of parameters in a database 160.

Although the MS 150 is shown as being a separate component from substation load tap changer voltage controller 50 and database 160, any or all of the functional elements may be integrated together. Such alternate embodiments are within the spirit and scope of the invention.

Communication network 80 allows a voltage monitor (VM) 300 to communicate with the MS 150. Communication network 80 may be formed of any medium that allows a VM 300 and MS 150 to communicate with one another. For example, communication network 80 may be the Internet and/or include a variety of communication mediums (e.g., cable, fiber, WiFi, WiMAX, DSL, etc.), a power line communication system (communicating over low voltage and/or medium voltage power lines), HomePlug network, HomePNA network, telephone network (e.g., landline or cellular), etc.

One or more customer premises 40 may be selected by an electric utility company as a desired point within the power grid 100 that will be voltage monitored. For example, customer premises 40g may be selected by an electric utility company as a desired location within the power grid 100 that will be voltage monitored. Customer premises 40g may be associated with substation 14 in memory of the MS 150. In other words, substation 14 is a substation that provides power to an MV power line 110 that supplies power to customer premises 40g. In addition, other utility equipment that can affect the voltage delivered to customer premises 40g may be associated in memory with customer premises 40g as well.

Voltage control may be an iterative process in which small changes in the voltage produced by substation 14 are determined to provide a resultant voltage at a customer premises 40 (under a given load and configuration). The resultant voltage from the adjustment may be further used to adjust the voltage produced by substation 14. This process may continue as needed to make the voltage produced by substation 14 as close to a target voltage (e.g., a regulatory requirement) as desired by an electric utility company.

Although only a single customer premises 40g is shown to include a VM 300, an electric utility company may select any number of customer premises 40 as locations within the power distribution system 100 to monitor a voltage. For example, an electric utility company may select multiple customer premises 40 that experience voltage drops as locations within the power distribution system to monitor a voltage. Monitoring of multiple customer premises 40 that have an approximately equal estimated voltage allows an electric utility company to assess whether their estimations for other parts of the power distribution system 100 comport with real world voltages for those particular locations. In another embodiment, the VM 300 comprises an automated electric utility meter and the VM 300 is therefore located at each and every customer premises 40 associated with an MV power line 110 or power grid 100.

The location of each VM 300 may be recorded in memory (e.g., in database 160) and associated with a customer premises (e.g., power customer). Each VM 300 may be assigned a unique VM 300 identification number (hereinafter “ID”). This unique VM 300 ID (which may comprise a Media Access Control (MAC) address) may be associated in memory with one or more substations 14 that provide power to that customer premises 40. In this manner, a location for a VM 300 that reports a voltage may be used to identify the substation 14 (and/or other utility equipment) that controls the voltage supplied thereto. Once a substation 14 (and/or other utility equipment) that affects the voltage of the power supplied to that customer premises is identified, additional processing of the voltage data may be performed and that substation 14 (and/or other utility equipment) may be provided a voltage instruction for supplying a new voltage to the medium voltage power line 110. Similarly, other utility equipment (e.g., capacitor banks, reclosers, switches, etc.) also may be associated in memory with a VM 300 as affecting the power (and voltage) supplied to the customer premises

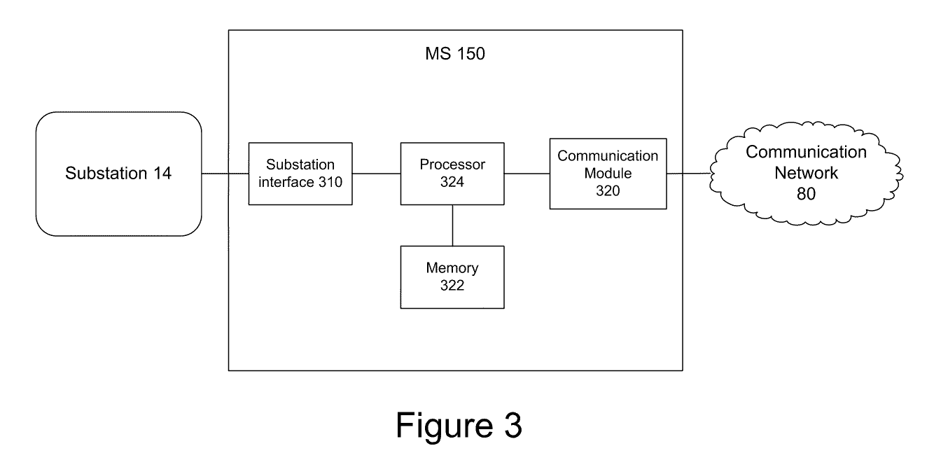

FIG. 3 shows a Monitoring System (MS) 150, in accordance with an example embodiment of the present invention. In particular, the MS 150 may include a processor 324, a substation interface 310 and a communication module 320. In some embodiments, the MS 150 may be a general purpose computer with a processor executing program code stored in memory to perform the functions disclosed herein and store the data disclosed herein. In such an embodiment, only one communication interface may be necessary, which is used to communicate with the VMs 300 and the utility equipment.

Communication module 320 allows the MS 150 to communicate with one or more VMs 300. Communication module 320 may be any of a variety of communications modules suitable for a particular communication medium. Communication module 320 may be a twisted pair modem, an Ethernet adapter, a cable modem, a fiber optic adapter, a wireless modem, a mobile telephone transceiver, etc. Communication module 320 may include an appropriate transmit buffer and receive buffer, as is known within the art. Thus, communication module 320 may be any type of data interface that allows the MS 150 to communicate with the VMs 300.

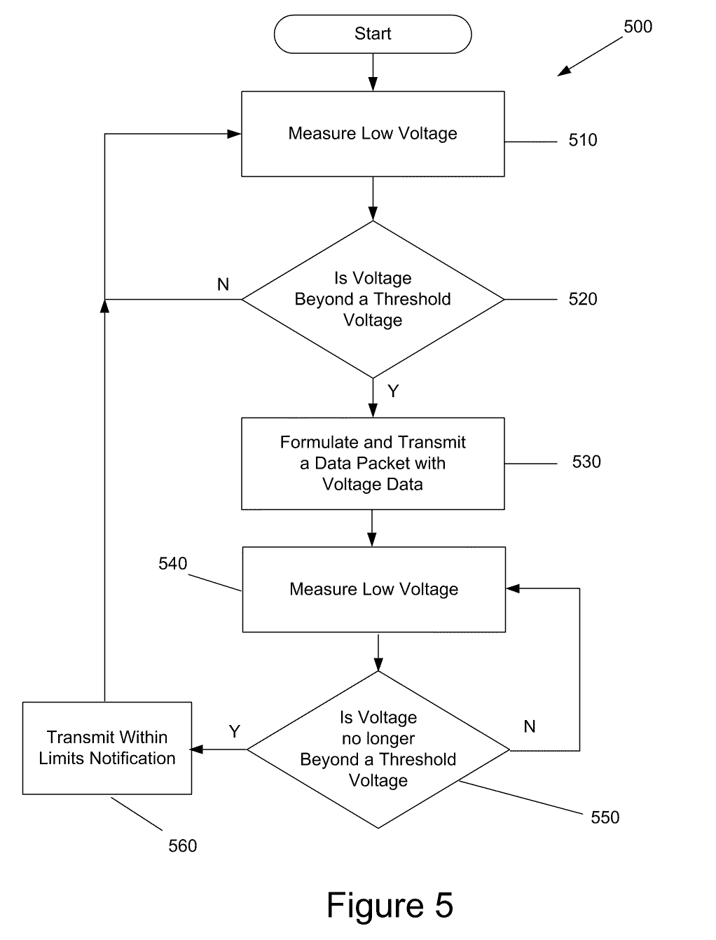

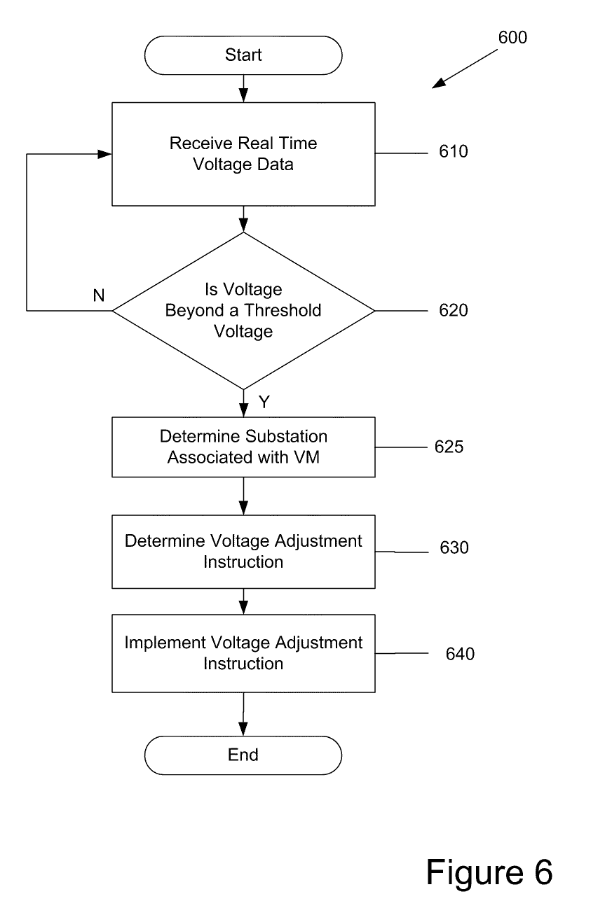

Substation interface 310 is used to communicate with the substation load tap changer controller 50 and may include a transceiver for communicating with the substation load tap changer controller 50. The substation interface 310 may also be used to communicate with other utility equipment (hereinafter meant to include capacitor banks, switches, and/or other utility infrastructure that can be used to affect the power delivered to a customer premises) that are connected to an MV power line supplied power by a particular substation 14. In some embodiments, only a single interface is used for all communications. The processor 324 may formulate and send one or more voltage instructions to substation 14 (and/or other utility equipment) via the substation interface 310. As discussed in more detail with relation to FIGS. 5 and 6, processor 324 may determine a new voltage for substation 14 based on a voltage as measured at a CP 40 (and current and configuration data) and/or a new configuration for other utility equipment. Processor 324 also may determine the substation 14 that is associated with a particular VM 300 (i.e., the customer premises 40 at which the VM 300 is located) by retrieving such information from memory 322 (or database 160). Depending upon the particular equipment used at a substation 14 (or the command suitable for the other utility equipment receiving the command), processor 324 forms an appropriate voltage adjustment instruction to instruct substation 14 to change the supplied voltage (or to instruct the other utility equipment to modify its configuration) accordingly. For example, the Load Tap Changer (LTC) controller 50 may put in a manual mode and transmitted RAISE or LOWER commands from the MS 150. In this example, the present invention fully takes over the function of the LTC controller and simply uses it as a path to control the LTC itself. In another example, the LTC controller 50 configuration/settings may be adjusted so that the LTC controller 50 uses its internal logic to issue the RAISE or LOWER command. This method has the benefit of taking advantage of all of the LTC controller basic functions (so they do not need to be recreated in (or performed by) the MS 150) and also allows for the potential that the MS 150 stops working or cannot communicate with the LTC controller 50. If that were to occur, the LTC controller 50 would continue to try to keep voltages at the most recent voltage level.

The communication module 320 also may allow the MS 150 to communicate with the database 160. Alternately, the database 160 may be an integral part of the MS 150.

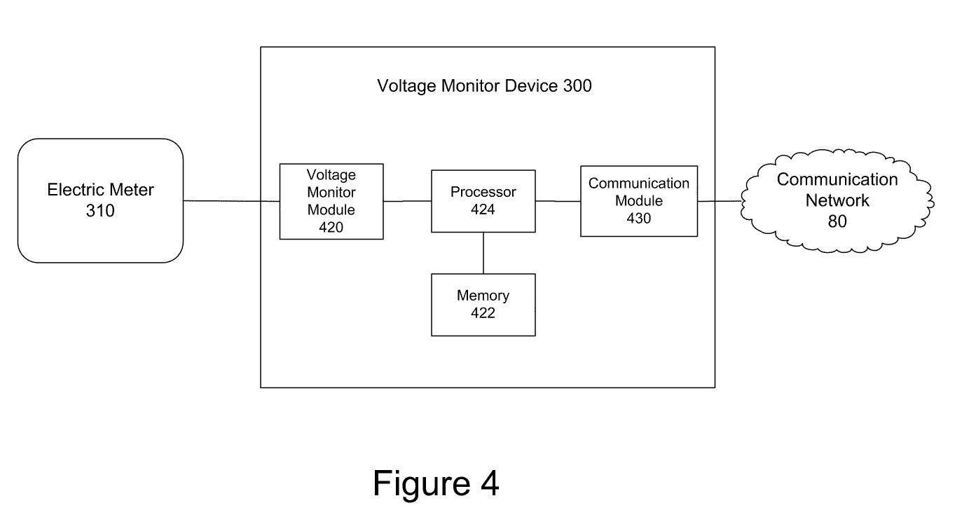

FIG. 4 shows voltage monitor (VM) 300, in accordance with an example embodiment of the present invention. In particular, the voltage monitor 300 may include a voltage monitor module 420, communication module 430, a processor 424 and a memory 422. Processor 424 may control the operation of the other components and execute program code in memory 422 to do so.

The voltage monitor module 420 measures the RMS voltage of the first and second low voltage power line energized conductor, or may measure the voltage between the two energized conductors (as opposed to measuring the voltage on each with respect to ground or neutral). Thus, the voltage monitor module 420 may include an analog to digital converter or a digital signal processor. The measurement RMS voltage data is provided to processor 424, which may average the two measurements or add them together. If the voltage between the two energized conductors is measured, no additional processing may be necessary. The voltage data (i.e., the average, the combined (in the case where the voltage between the two energized conductors is measured) or the measured voltage data) may be compared to a first and/or second threshold value stored in memory. The processor 424 may provide the voltage data and/or an alert to be transmitted by communication module 430. In addition to measuring the voltage over time (i.e., monitoring the voltage), the voltage monitor (or more generally the electricity monitor) may also be configured to measure and monitor the power factor, harmonics, voltage noise, voltage sags, voltage spikes, peak-to-peak voltage.

If a neutral or ground conductor becomes loose, the voltage on one LV energized conductor may become much higher than the voltage on the other LV energized conductor (e.g., 110 volts and 130 volts). If such measurement data (from either conductor) were used to determine whether to adjust the voltage, the system might inappropriately provide a voltage adjustment. By adding the two voltages together, by averaging them, or by measuring the voltage across the two conductors, the system overcomes the obstacle of a loose neutral (or other such misleading event) causing a voltage adjustment. However, the VM 300 may be configured to send the voltage data as measured on each LV energized conductor to the MS 150 (or elsewhere) when the difference between the two measured voltages (of each LV energized conductor) exceeds a threshold stored in memory (e.g., greater than five volts) to thereby notify the MS 150 that a loose neutral may be present. The MS 150 may output a notification and/or report indicating the locations (e.g., addresses) where a loose neutral may be present.

The communication module 430 allows the VM 300 to communicate with the MS 150. Communication module 430 may be any of a variety of communications modules that are suitable for a particular communication medium. Communication module 430 may be a power line modem, a twisted pair modem, an Ethernet adapter, a fiber optic transceiver, a Wifi transceiver, a mobile telephone network transceiver, etc. Communication module 430 may include an appropriate transmit buffer and receive buffer, as is known within the art. Thus, communication module 430 may be any type of data interface that allows the VM 300 to communicate with a MS 150.

Memory 422 may store voltage data as measured by the voltage monitor 420 and time stamp data (date and time) for each measurement (hereinafter to include each pair of measurements (one for each energized conductor) in such an embodiment). Memory 422 may also store a unique ID (e.g., serial) number for the VM 300 that allows a MS 150 to uniquely identify the VM 300 on the power grid 100. In some embodiments, memory 422 may store program code to be executed by processor 424 as well as parameters such as threshold values (minimum and maximum voltages) that are used as a basis to transmit an alert to the MS 150, if the VM 300 is so configured. More specifically, the processor 424 may compare the measurement data from the voltage monitor 420 with the minimum and maximum threshold data retrieved from memory and, if a threshold is exceeded (too high or low) the processor 424 transmits an alert to the MS 150 via the communication module 430. In addition or alternately, the MS 150 may request voltage (and other) data from the VM 300 (by transmitting a request) and the processor 424, in response to receiving the request, retrieves the time stamped data from memory 422 and transmits the time stamped data to the MS 150. The memory 422 may also store frequency data that includes data for controlling the frequency of voltage measurements to be made by the voltage monitor 420 as controlled by processor 424. Thus, the MS 150 may receive from the VMs 300 real time alerts and/or real time voltage data such as data of measurements within five minutes, more preferably within two minutes, even more preferably within one minute, and yet more preferably within fifteen seconds of the voltage measurement.

The MS 150 (or other computer system) may transmit program code, gateway IP address(es), frequency data, and/or threshold values for storage in memory 422 of the VM 300 to be used by the processor 424 to perform various processing. The voltage data and its associated time stamp data may be communicated (e.g. along with power usage data for the associated customer premises) to the MS 150 at any convenient time such as during monthly meter readings for billing purposes and/or at night when bandwidth usage of the communication network is typically low.

In this embodiment, the monitor 300 comprises an electric power meter. In addition, other voltage monitors 300 in this embodiment (or in other embodiments) may be co-located at a distribution transformer 60 (that steps down the medium voltage to low voltage) and connected to the external low voltage power lines supplying power to a plurality of customer premises. More specifically, the VM 300 may form part of a transformer bypass device (sometimes referred to herein as an access node) that provides communication services to the automated meter disposed at each customer premises. As discussed below, each bypass device may be connected to a low voltage power line and a medium voltage power line for communication to a backhaul device that forms the interface between the power line communication system and a conventional (non-power line) communication system such as a fiber, cable, or wireless network. Each transformer bypass device may be in communication with one or more electric power meters wirelessly or via the low voltage power lines. While the following discussion describes the VM 300 as an electric power meter, the VM 300 may additionally (or alternately) be integrated into (or in communication with) a bypass device to measure the voltage of the external low power lines. The bypass device or a remote computer system, in some embodiments, may be configured to factor in (subtract) a small voltage from the measured voltage that is estimated to be the voltage drop between the distribution transformer (the place of the voltage measurement) and the electric power meter to thereby account for the voltage drop over the external low voltage power lines (between the place of measurement and the place of power delivery).

FIG. 5 is a process 500 for monitoring a voltage delivered to a customer premises 40 and identifying an alert condition, in accordance with an example embodiment of the present invention. As discussed, at step 510 the RMS AC voltage of a first energized low voltage conductor and of a second low voltage energized conductor may be measured by the VM 300. Processor 424 may store the data of measured voltages in memory 422. In some embodiments, other parameters (discussed above) may also be measured and stored. The processor 424 may store additional data such as the time of measurement, the date of measurement, etc. Thus, a history of voltages measured over a period of time may be stored in the memory 422 to allow a historical determination of changing voltages. In some embodiments, the voltage measurements may be averaged or combined and in other embodiments the voltage between the two energized conductors is measured. In addition, where the VM 300 measures the external LV energized conductors at the distribution transformer, the process may further include subtracting an estimated external LV line loss (although, instead, different thresholds may be used).

At step 520, processor 424 may determine if the RMS voltage data is beyond a threshold voltage (either greater than a high threshold and/or less than a low threshold). For example, processor 424 may compare the voltage data with each of a high and low threshold to determine if the measured voltage is above a high threshold or below a low threshold. As a more specific example, the processor 224 (or alternately the DSP (Digital Signal Processor) forming part voltage monitor 420) may determine if the measured voltage is within six percent of a nominal voltage (e.g., 120 volts) that is, determine if the measured voltage is below 112.8 volts RMS or above 127.2 volts RMS.

If at step 520 the process 500 determines that the measured voltage is not beyond a threshold voltage, the process branches to step 510 to take additional measurements. In this manner the process 500 may continuously monitor for a voltage that is either too high or too low, and may provide real-time voltage data to the MS 150. If at step 520 the process determines that the measured voltage is beyond a threshold voltage, the process branches to step 530.

At step 530, the voltage data measured in step 510 may be formulated into one or more data packet(s) by processor 424 and transmitted to provide an alert notification to the MS 150 in real-time (or near real-time) of the voltages that are beyond a threshold. The notification may include time stamp data for the measurement and information identifying the VM 300 to allow the MS 150 to determine the location of the voltage measurement (and the substation providing the voltage to that location). The voltage data from each (or some) measurements also may be stored in memory 422. In addition to transmitting an alert, processor 424 may retrieve the most recently stored voltage data (e.g., the last hour or day), and/or more historical voltage data (e.g., the last week or month), from the memory 422 and provide the voltage data to communication module 430 for transmission to the MS 150. The transmission of data may be caused by processor 424 in accordance with program code that causes periodic data transmission or may be performed in response to receiving a request for data from the MS 150. The data packet(s) may be placed into a transmit data buffer of communication module 430. Communication module 430 may then transmit the voltage data packet(s) over the communication medium, through the internet to the MS 150 or via any other suitable communication path such as wirelessly.

In some embodiments, the communication of voltage data itself provides an alert that a voltage is either too high or too low. In some embodiments, voltage data may be communicated to a MS 150 on a periodic basis (either in real time or not), whether the measured voltage is considered a “normal” value (not beyond a threshold) or not. In such an instance, the MS 150 may make the sole determination as to whether the measured voltage is either too high or too low.

At step 540, and after it has been determined that the voltage is beyond a threshold and an alert transmitted at 530, the VM 30 may continue to measure the voltage at process 540 (as was performed at step 510). At process 550, the processor may compare the voltage measurements of step 540 with the threshold values in memory to determine whether the voltage remains beyond the threshold value. If the voltage remains beyond the threshold, the process continues to step 540. If the voltage is no longer beyond a threshold, the process continues to 560 and the VM 300 may transmit a “within limits” notification, when (after being beyond a threshold) the voltage is no longer beyond that threshold (e.g., so that the MS knows when to stop adjusting the voltage). After transmission of the Within Limits notification, the process returns to process 510 and continues to measure the voltage of the low voltage conductors.

FIG. 6 illustrates a method of adjusting a voltage at a substation 14, in accordance with an example embodiment of the present invention. As discussed, at step 610 the MS 150 may receive one or more data transmissions with voltage data as measured by one or more VMs 300 at one or more customer premises 40 (or at nearby distribution transformers). The data transmission may also include information identifying the VM 300 (or bypass device) making the measurement and time and date data. More specifically, the voltage data from one or more measurements by a VM 300 in step 510 (and other data) and that are transmitted in step 530 is received by a receive buffer within communication module 320.

At step 620, processor 324 may determine if a measured voltage is beyond a threshold voltage value (either greater than a high threshold value or less than a lower threshold value). For example, processor 324 may compare the measured voltage with each of a high and low threshold to determine if the measured voltage is above a high threshold or below a low threshold. If at step 620 it is determined that the measured voltage is not beyond a threshold voltage, the process branches to step 610 to wait for (and/or process) additional data. In some embodiments, the received data may be stored in memory for later processing. If at step 620 the process determines that the measured voltage is beyond a threshold voltage, the process branches to step 625.

At step 625, processor 324 determines the particular substation 14 that is associated with the customer premises 40 having a voltage that is either too high or too low. For example, the processor may query the database for a location (e.g., an address) associated with the identifying information of the VM 300, which is received with the voltage data. Upon determining the location, the process determines the substation supplying power to that location by, for example, querying a database. Note that in some embodiments, this step may be omitted if, for example, each MS 150 (of multiple MSs 150 controls) only a single substation. In addition, in some embodiments it may be desirable to determine one or more capacitor banks (and/or other utility equipment) that can be modified to adjust the voltage delivered.

At step 630, the voltage data received from the VM 300 in step 610 may be used to determine a voltage adjustment instruction by processor 324. Processor 324 may retrieve the most recently received voltage data (and, in some instances, the most recent voltage adjustment instruction) from the memory 322 and formulate an appropriate substation voltage adjustment instruction in accordance with the requirements of the particular substation 14 employed to control the voltage on the medium voltage power line 10. A historical record of the substation voltage adjustment instruction may be stored in the voltage adjusting storage 322. The voltage adjustment instruction may be either a new voltage to be supplied (e.g., 15,152 volts) or a voltage adjustment (e.g., increase by 93 volts or decrease by 70 volts). In some instances, the voltage instruction may be transmitted to the substation controller 50, in which case the data packet(s) may be placed into a transmit data buffer of voltage adjusting module 310 for transmission to substation 14. In other embodiments the MS 150 may form part of the same computer system as controller 50, in which case transmission may not be necessary. In other embodiments, the instruction may be transmitted to other utility equipment.

At step 640, the substation 14 implements the voltage adjustment instruction formulated in step 630 to appropriately adjust substation 14. Thus, substation voltage controller, upon receipt of the voltage adjustment instruction, may respond appropriately causing the substation 14 to adjust the voltage supplied to the medium voltage power line 110 in accordance with the voltage adjustment instruction. In other instances, the other utility equipment may implement the received instruction such as, for example, switching in additional capacitance to increase the voltage delivered.

After transmitting the voltage adjustment instruction, the MS 150 may wait a predetermined time period (e.g., fifteen minutes). If during the predetermined time period a Within Limits notification is received from the VM transmitting the alert notification, no other adjustment may need to be immediately made. If a Within Limits notification is not received within the predetermined time period, another incremental voltage adjustment in the same direction (e.g., higher or lower) may be made by sending another voltage adjustment instruction (e.g., to the same or a different device) to further adjust the voltage in hopes of bringing the voltage within the desired thresholds. The process of adjusting the voltage and waiting for a within limits notification may be repeated until the a within limits notification is received.

As is evident from the above description, step 520 may determine if a voltage is either too high or too low as measured at a customer premises 40 and step 620 also may determine if a voltage is too high or too low as determined by the MS 150. However, the MS 150 may use different threshold voltages for its determinations than those used by the VMs 300. For example, the VMs 300 may report voltages beyond thresholds and thereby provide a preliminary alert that a voltage is beyond a first threshold (and getting close to a second threshold), while the MS 150 may, for example, make the determination that the voltage is beyond the second threshold warranting a voltage adjustment. Thus, the VM 300 alerts may be used to give a warning that, should loads change significantly, the voltage at a customer premises 40 is at risk of dropping below a threshold voltage (the threshold used by VCM).

In this manner, a pre-established threshold voltage that controls whether the voltage is adjusted by the substation 14 can be more easily controlled at a centralized location, such as the MS 150. This may be helpful in the event that a pre-established threshold voltage requires adjustment. In some embodiments, step 620 is omitted and in other embodiments, the VM 300 transmits all voltage data and step 520 may be omitted.

In one embodiment, the VMs 300 of a plurality of bypass devices and/or automated electric power meters may be programmed to transmit alerts upon detection of a voltage beyond a threshold and are also periodically polled by the MS for voltage data and transmit the measured voltage of the two energized low voltage conductors or the averaged (or summed) voltage data in response to the polling.

In some instances, it may be desirable to maintain the voltage at just slightly above the minimum regulatory voltage (e.g. 113 V), which would be desirable for areas (e.g., an MV power line run) where the overall load of the power customers has a significant portion that is variable in that the power (and energy) consumed by the variable load reduces as the voltage reduces. Another type of load is referred to herein as fixed loads in which the load draws a fixed amount of power regardless of the voltage. When the voltage supplied to a fixed load is reduced, the fixed loads will draw more current to thereby draw the same amount of power. Thus, in some areas where a significant portion of the load is of the fixed load type, it may be desirable to maintain the voltage supplied to the area to a voltage just below the maximum regulatory voltage (e.g., 127 V). By increasing the voltage, the fixed loads draw less current and less current conducted through the power distribution system may reduce power distribution losses (e.g., from power lines and distribution transformers, etc.).

In some embodiments, some areas (e.g., neighborhoods, counties, MV power line runs, etc.) may be profiled as a fixed load area or variable load area and such information may be stored in memory. Thus, it may be desirable to maintain the highest possible voltage (below the regulatory maximum) in some fixed load profile areas and maintain the lowest possible voltage (above the regulatory minimum) in some variable load profile areas. The determination of whether an area should be considered a fixed load area or a variable load area may be performed via any suitable means such by inventory the loads of all or a sample of power customers in an area, based on demographics, based on property taxes, based on income, another means, or some combination thereof. In addition, the determined profile (whether area is a fixed load area or a variable load area) may change depending on the time of day, day of the week, temperature, time of the year, and/or other suitable variable.

The utility equipment to which the voltage adjustment instructions are transmitted may be stored in memory of the MS 150 in accordance with the priority desired by the utility. For example, some utilities may prefer to adjust the voltage delivered to customers by first adjusting the voltage supplied by the substation, and secondly by adjusting the capacitance supplied by a capacitor bank. Other utilities may prefer to adjust the voltage delivered to customers by first adjusting the capacitance supplied by a capacitor bank and secondly adjusting the voltage supplied by the substation. These preferences may also vary depending on the existing load (i.e., current draw), the time day, week, or year, etc.

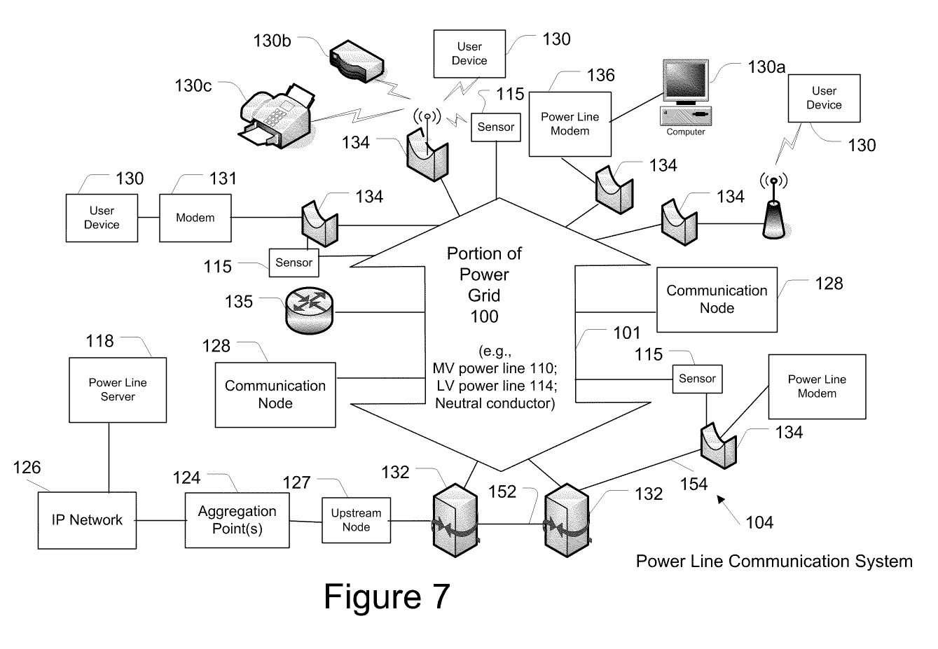

As discussed, embodiments of the present invention may make use of a power line communication system for communicating voltage data. In addition, embodiments of the present invention may be formed of, at least in part, by elements of a power line communication system. As shown in FIG. 7, an example power line communication system may include a plurality of communication nodes 128 which form communication links using power lines 110, 114 and other communication media. One type of communication node 128 may be a backhaul node 132. Another type of communication node 128 may be an access node 134 (or bypass device). Another type of communication node 128 may be a repeater node 135. A given node 128 may serve as a backhaul node 132, access node 134, and/or repeater node 135.

A communication link is formed between two communication nodes 128 over a communication medium. Some links may be formed over MV power lines 110. Some links may be formed over LV power lines 114. Other links may be gigabit-Ethernet links 152, 154 formed, for example, using a fiber optic cable. Thus, some links may be formed using a portion of the power system infrastructure 100, while other links may be formed over another communication media, (e.g., a coaxial cable, a T-1 line, a fiber optic cable, wirelessly (e.g., IEEE 802.11a/big, 802.16, 1G, 2G, 3G, or satellite such as WildBlue®)). The links formed by wired or wireless media may occur at any point along a communication path between a backhaul node 132 and a user device 130.

Each communication node 128 may be formed by one or more communication devices. Communication nodes which communicate over a power line medium include a power line communication device. Exemplary power line communication devices include a backhaul device 138, an access device 139, and a repeater 135. Communication nodes communicate via a wireless link may include a wireless access point having at least a wireless transceiver, which may comprise mobile telephone cell site/transceiver (e.g., a micro or pico cell site) or an IEEE 802.11 transceiver (Wifi). Communication nodes which communicate via a coaxial cable may include a cable modem. Communication nodes which communicate via a twisted pair may include a DSL modem. A given communication node typically will communicate in both directions (either full duplex or half duplex) of its link, which may be over the same or different types of communication media. Accordingly, a communication node 128 may include one, two or more communication devices, which may communicate along the same or different types of communication media.

A backhaul node 132 may serve as an interface between a power line medium (e.g., an MV power line 110) of the system 104 and an upstream node 127, which may be, for example, connected to an aggregation point 124 that may provide a connection to an IP network 126. The system 104 typically includes one or more backhaul nodes 132. Upstream communications from user premises and control and monitoring communications from power line communication devices may be communicated to an access node 134, to a backhaul node 132, and then transmitted to an aggregation point 124 which is communicatively coupled to the IP network 126. Communications may traverse the IP network to a destination, such as a web server, power line server 118, or an end user device. The backhaul node 132 may be coupled to the aggregation point 124 directly or indirectly (i.e., via one or more intermediate nodes 127). The backhaul node 132 may communicate with its upstream device via any of several alternative communication media, such as a fiber optic cable (digital or analog (e.g., Wave Division Multiplexed)), coaxial cable, WiMAX, IEEE 802.11, twisted pair and/or another wired or wireless media. Downstream communications from the IP network 126 typically are communicated through the aggregation point 124 to the backhaul node 132. The aggregation point 124 typically includes an Internet Protocol (IP) network data packet router and is connected to an IP network backbone, thereby providing access to an IP network 126 (i.e., can be connected to or form part of a point of presence or POP). Any available mechanism may be used to link the aggregation point 124 to the POP or other device (e.g., fiber optic conductors, T-carrier, Synchronous Optical Network (SONET), and wireless techniques).

An access node 134 may transmit data to and receive data from, one or more user devices 130 or other network destinations. Other data, such as power line parameter data (e.g., voltage data from a voltage sensor and/or current data as measured by a power line current sensor device) may be received by an access node's power line communication device 139. The data enters the network 104 along a communication medium coupled to the access node 134. The data is routed through the network 104 to a backhaul node 132. Downstream data is sent through the network 104 to a user device 130. Exemplary user devices 130 include a computer 130a, LAN, a WLAN, router 130b, Voice-over IP endpoint, game system, personal digital assistant (PDA), mobile telephone, digital cable box, security system, alarm system (e.g., fire, smoke, carbon dioxide, security/burglar, etc.), stereo system, television, fax machine 130c, HomePlug residential network, or other user device having a data interface. The system also may be used to communicate utility usage data from automated gas, water, and/or electric power meters. A user device 130 may include or be coupled to a modem to communicate with a given access node 134. Exemplary modems include a power line modem 136, a wireless modem 131, a cable modem, a DSL modem or other suitable modem or transceiver for communicating with its access node.

A repeater node 135 may receive and re-transmit data (i.e., repeat), for example, to extend the communications range of other communication elements. As a communication traverses the communication network 104, backhaul nodes 132 and access nodes 134 also may serve as repeater nodes 135, (e.g., for other access nodes and other backhaul nodes 132). Repeaters may also be stand-alone devices without additional functionality. Repeaters 135 may be coupled to and repeat data on MV power lines or LV power lines (and, for the latter, be coupled to the internal or external LV power lines).

Various user devices 130 and power line communication devices (PLCD) may transmit and receive data over the communication links to communicate via an IP network 126 (e.g., the Internet). Communications may include measurement data of power distribution parameters, control data and user data. For example, power line parameter data and control data may be communicated to a power line server 118 for processing. A power line parameter sensor device 115 (e.g., a voltage monitor) may be located in the vicinity of, and communicatively coupled to, a power line communication device 134, 135, 132 (referred to herein as PLCD 137 for brevity and to mean any of power line communication devices 134, 135, or 132) to measure or detect power line parameter data.

### Backhaul Device 138:

Communication nodes, such as access nodes, repeaters, and other backhaul nodes, may communicate to and from the IP network (which may include the Internet) via a backhaul node 132. In one example embodiment, a backhaul node 132 comprises a backhaul device 138. The backhaul device 138, for example, may transmit communications directly to an aggregation point 124, or to a distribution point 127 which in turn transmits the data to an aggregation point 124.

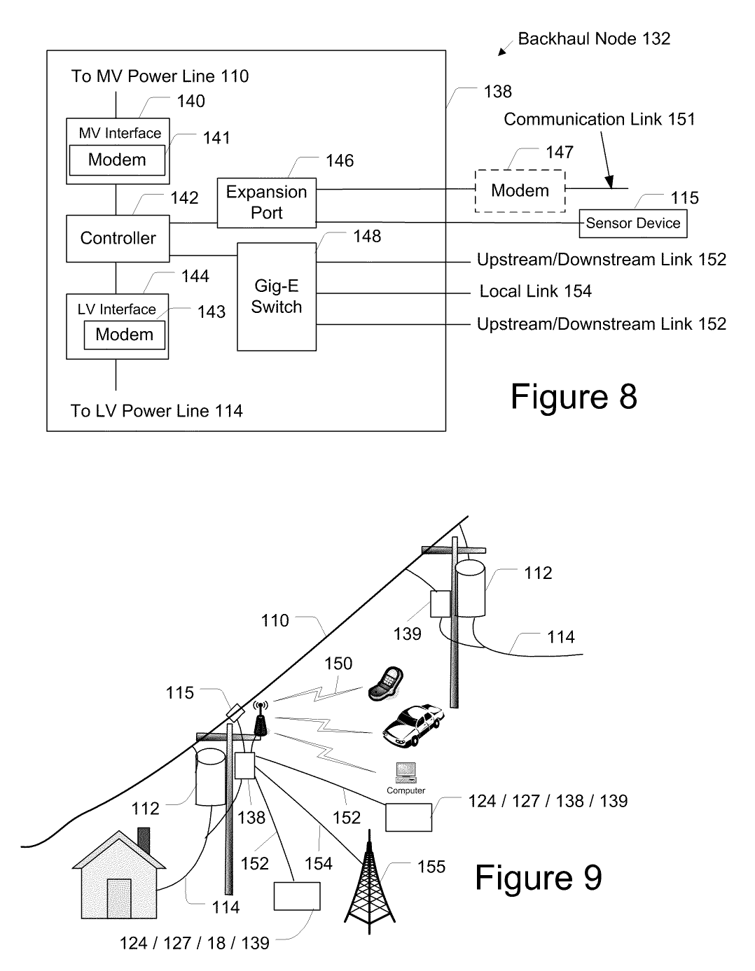

FIGS. 8 and 9 show an example embodiment of a backhaul device 138 which may form all or part of a backhaul node 132. The backhaul device 138 may include a medium voltage power line interface (MV Interface) 140, a controller 142, an expansion port 146, and a gigabit Ethernet (gig-E) switch 148. In some embodiments the backhaul device 138 also may include a low voltage power line interface (LV interface) 144. The MV interface 140 is used to communicate over the MV power lines and may include an MV power line coupler coupled to an MV signal conditioner, which may be coupled to an MV modem 141. The MV power line coupler prevents the medium voltage power from passing from the MV power line 110 to the rest of the device's circuitry, while allowing the communications signal to pass between the backhaul device 138 and the MV power line 110. The MV signal conditioner may provide amplification, filtering, frequency translation, and transient voltage protection of data signals communicated over the MV power lines 110. Thus, the MV signal conditioner may be formed by a filter, amplifier, a mixer and local oscillator, and other circuits which provide transient voltage protection. The MV modem 141 may demodulate, decrypt, and decode data signals received from the MV signal conditioner and may encode, encrypt, and modulate data signals to be provided to the MV signal conditioner.

The backhaul device 138 also may include a low voltage power line interface (LV Interface) 144 for receiving and transmitting data over an LV power line 114. The LV interface 144 may include an LV power line coupler coupled to an LV signal conditioner, which may be coupled to an LV modem 143. In one embodiment the LV power line coupler may be an inductive coupler. In another embodiment the LV power line coupler may be a conductive coupler. The LV signal conditioner may provide amplification, filtering, frequency translation, and transient voltage protection of data signals communicated over the LV power lines 114. Data signals received by the LV signal conditioner may be provided to the LV modem 143. Thus, data signals from the LV modem 143 are transmitted over the LV power lines 110 through the signal conditioner and coupler. The LV signal conditioner may be formed by a filter, amplifier, a mixer and local oscillator, and other circuits which provide transient voltage protection. The LV modem 143 may demodulate, decrypt, and decode data signals received from the LV signal conditioner and may encode, encrypt, and modulate data signals to be provided to the LV signal conditioner.

The backhaul device 138 also may include an expansion port 146, which may be used to connect to a variety of devices. For example a wireless access point, which may include a wireless transceiver or modem 147, may be integral to or coupled to the backhaul device 138 via the expansion port 146. The wireless modem 147 may establish and maintain a communication link 151. In other embodiments a communication link is established and maintained over an alternative communications medium (e.g., fiber optic, cable, twisted pair) using an alternative transceiver device. In such other embodiments the expansion port 146 may provide an Ethernet connection allowing communications with various devices over optical fiber, coaxial cable or other wired medium. In such embodiment the modem 147 may be an Ethernet transceiver (fiber or copper) or other suitable modem may be employed (e.g., cable modem, DSL modem). In other embodiments, the expansion port may be coupled to a Wifi access point (IEEE 802.11 transceiver), WiMAX (IEEE 802.16), or mobile telephone cell site. The expansion port may be employed to establish a communication link 151 between the backhaul device 138 and devices at a residence, building, other structure, another fixed location, or between the backhaul device 138 and a mobile device.

Various sensor devices 115 also may be connected to the backhaul device 138 through the expansion port 146 or via other means (e.g., a dedicated sensor device interface not shown). Exemplary sensors that may form part of a power distribution parameter sensor device 115 and be coupled to the backhaul device 138 may include, a current sensor, voltage sensor, a level sensor (to determine pole tilt), a camera (e.g., for monitoring security, detecting motion, monitoring children's areas, monitoring a pet area), an audio input device (e.g., microphone for monitoring children, detecting noises), a vibration sensor, a motion sensor (e.g., an infrared motion sensor for security), a home security system, a smoke detector, a heat detector, a carbon monoxide detector, a natural gas detector, a thermometer, a barometer, a biohazard detector, a water or moisture sensor, a temperature sensor, and a light sensor. The expansion port may provide direct access to the core processor (which may form part of the controller 142) through a MII (Media Independent Interface), parallel, serial, or other connection. This direct processor interface may then be used to provide processing services and control to devices connected via the expansion port thereby allowing for a more less expensive device (e.g., sensor). The power parameter sensor device 115 may measure and/or detect one or more parameters, which, for example, may include power usage data, power line voltage data (both energized conductors), power line current data, detection of a power outage, detection of water in a pad mount, detection of an open pad mount, detection of a street light failure, power delivered to a transformer data, power factor data (e.g., the phase angle between the voltage and current of a power line), power delivered to a downstream branch data, data of the harmonic components of a power signal, load transients data, and/or load distribution data. In addition, the backhaul device 138 may be connected to multiple sensor devices 115 so that parameters of multiple power lines may be measured such at a separate parameter sensor device 115 on each of three MV power line conductors 110 and a separate parameter sensor device on each of two energized LV power line conductors 114 and one on each neutral conductor. One skilled in the art will appreciate that other types of utility data also may be gathered. As will be evident to those skilled in the art, the expansion port may be coupled to an interface for communicating with the interface 206 of the sensor device 114 via a non-conductive communication link.

The backhaul device 138 also may include a gigabit Ethernet (Gig-E) switch 148. Gigabit Ethernet is a term describing various technologies for implementing Ethernet networking at a nominal speed of one gigabit per second, as defined by the IEEE 802.3z and 802.3ab standards. There are a number of different physical layer standards for implementing gigabit Ethernet using optical fiber, twisted pair cable, or balanced copper cable. In 2002, the IEEE ratified a 10 Gigabit Ethernet standard which provides data rates at 10 gigabits per second. The 10 gigabit Ethernet standard encompasses seven different media types for LAN, MAN and WAN. Accordingly the gig-E switch may be rated at 1 gigabit per second (or greater as for a 10 gigabit Ethernet switch).

The switch 148 may be included in the same housing or co-located with the other components of the node (e.g., mounted at or near the same utility pole or transformer). The gig-E switch 148 maintains a table of which communication devices are connected to which switch 148 port (e.g., based on MAC address). When a communication device transmits a data packet, the switch receiving the packet determines the data packet's destination address and forwards the packet towards the destination device rather than to every device in a given network. This greatly increases the potential speed of the network because collisions are substantially reduced or eliminated, and multiple communications may occur simultaneously.

The gig-E switch 148 may include an upstream port for maintaining a communication link 152 with an upstream device (e.g., a backhaul node 132, an aggregation point 124, a distribution point 127), a downstream port for maintaining a communication link 152 with a downstream device (e.g., another backhaul node 132; an access node 134), and a local port for maintaining a communication link 154 to a Gig-E compatible device such as a mobile telephone cell cite 155 (i.e., base station), a wireless device (e.g., WiMAX (IEEE 802.16) transceiver), an access node 134, another backhaul node 132, or another device. In some embodiments the gig-E switch 148 may include additional ports.

In one embodiment, the local link 154 may be connected to mobile telephone cell site configured to provide mobile telephone communications (digital or analog) and use the signal set and frequency bands suitable to communicate with mobile phones, PDAs, and other devices configured to communicate over a mobile telephone network. Mobile telephone cell sites, networks and mobile telephone communications of such mobile telephone cell sites, as used herein, are meant to include analog and digital cellular telephone cell sites, networks and communications, respectively, including, but not limited to AMPS, 1G, 2G, 3G, GSM (Global System for Mobile communications), PCS (Personal Communication Services) (sometimes referred to as digital cellular networks), 1× Evolution-Data Optimized (EVDO), and other cellular telephone cell sites and networks. One or more of these networks and cell sites may use various access technologies such as frequency division multiple access (FDMA), time division multiple access (TDMA), or code division multiple access (CDMA) (e.g., some of which may be used by 2G devices) and others may use CDMA2000 (based on 2G Code Division Multiple Access), WCDMA (UMTS)—Wideband Code Division Multiple Access, or TD-SCDMA (e.g., some of which may be used by 3G devices).

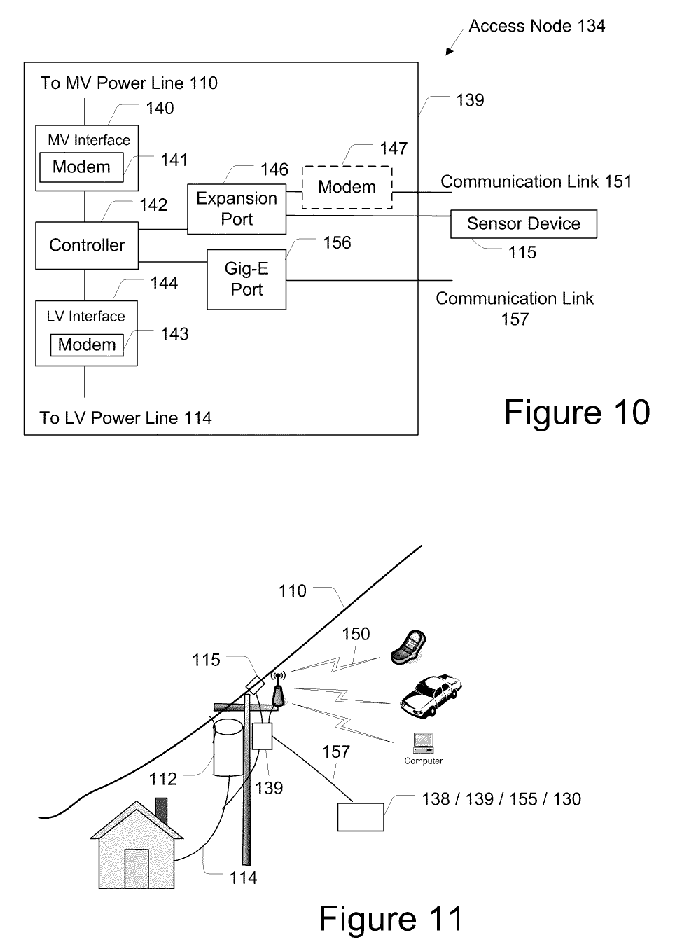

The gig-E switch 148 adds significant versatility to the backhaul device 138. For example, several backhaul devices may be coupled in a daisy chain topology (see FIG. 10), rather than by running a different fiber optic conductor to each backhaul node 134. Additionally, the local gig-E port allows a communication link 154 for connecting to high bandwidth devices (e.g., WiMAX (IEEE 802.16) or other wireless devices). The local gig-E port may maintain an Ethernet connection for communicating with various devices over optical fiber, coaxial cable or other wired medium. Exemplary devices may include user devices 130, a mobile telephone cell cite 155, and sensor devices (as described above with regard to the expansion port 146.

Communications may be input to the gig-E switch 148 from the MV interface 140, LV interface 144 or expansion port 146 through the controller 142. Communications also may be input from each of the upstream port, local port and downstream port. The gig-E switch 148 may be configured (by the controller 142 dynamically) to direct the input data from a given input port through the switch 148 to the upstream port, local port, or downstream port. An advantage of the gig-E switch 148 is that communications received at the upstream port or downstream port need not be provided (if so desired) to the controller 142. Specifically, communications received at the upstream port or downstream port may not be buffered or otherwise stored in the controller memory or processed by the controller. (Note, however, that communications received at the local port may be directed to the controller 142 for processing or for output over the MV interface 140, LV interface 144 or expansion port 146). The controller 142 controls the gig-E switch 148, allowing the switch 148 to pass data upstream and downstream (e.g. according to parameters (e.g., prioritization, rate limiting, etc.) provided by the controller). In particular, data may pass directly from the upstream port to the downstream port without the controller 142 receiving the data. Likewise, data may pass directly from the downstream port to the upstream port without the controller 142 receiving the data. Also, data may pass directly from the upstream port to the local port in a similar manner; or from the downstream port to the local port; or from the local port to the upstream port or downstream port. Moving such data through the controller 142 would significantly slow communications or require an ultra fast processor in the controller 142. Data from the controller 142 (originating from the controller 142 or received via the MV interface 140, the LV interface 144, or expansion port 146) may be supplied to the Gig-E switch 148 for communication upstream (or downstream) via the upstream port (or downstream port) according to the address of the data packet. Thus, data from the controller 142 may be multiplexed in (and routed/switched) along with other data communicated by the switch 148. As used herein, to route and routing is meant to include the functions performed by of any a router, switch, and bridge.

The backhaul device 138 also may include a controller 142 which controls the operation of the device 138 by executing program codes stored in memory. In addition, the program code may be executable to process the measured parameter data to, for example, convert the measured data to current, voltage, or power factor data. The backhaul 138 may also include a router, which routes data along an appropriate path. In this example embodiment, the controller 142 includes program code for performing routing (hereinafter to include switching and/or bridging). Thus, the controller 142 may maintain a table of which communication devices are connected to port in memory. The controller 142, of this embodiment, matches data packets with specific messages (e.g., control messages) and destinations, performs traffic control functions, performs usage tracking functions, authorizing functions, throughput control functions and similar related services. Communications entering the backhaul device 138 from the MV power lines 110 at the MV interface 140 are received, and then may be routed to the LV interface 144, expansion port 146 or gig-E switch 148. Communications entering the backhaul device 138 from the LV power lines 114 at the LV interface 144 are received, and may then be routed to the MV interface 140, the expansion port 146, or the gig-E switch 148. Communications entering the backhaul device 138 from the expansion port 146 are received, and may then be routed to the MV interface 140, the LV interface 144, or the gig-E switch 148. Accordingly, the controller 142 may receive data from the MV interface 140, LV interface 144 or the expansion port 146, and may route the received data to the MV interface 140, LV interface 144, the expansion port 146, or gig-E switch 148. In this example embodiment, user data may be routed based on the destination address of the packet (e.g., the IP destination address). Not all data packets, of course, are routed. Some packets received may not have a destination address for which the particular backhaul device 138 routes data packets. Additionally, some data packets may be addressed to the backhaul device 138. In such case the backhaul device may process the data as a control message.

### Access Device 139:

The backhaul nodes 132 may communicate with remote user devices via one or more access nodes 134, which may include an access device 139. FIGS. 10 and 11 show an example embodiment of such an access device 139 for providing communication services to electric power meters, mobile devices and to user devices at a residence, building, and other locations. Although FIG. 9 shows the access node 134 coupled to an overhead power line, in other embodiments an access node 134 (and its associated sensor devices 115) may be coupled to an underground power line.

In one example embodiment, access nodes 134 provide communication services for user devices 130 such as security management; IP network protocol (IP) packet routing; data filtering; access control; service level monitoring; service level management; signal processing; and modulation/demodulation of signals transmitted over the communication medium.

The access device 139 of this example node 134 may include a bypass device that moves data between an MV power line 110 and an LV power line 114. The access device 139 may include a medium voltage power line interface (MV Interface) 140 having a MV modem 141, a controller 142, a low voltage power line interface (LV interface) 144 having a LV modem 143, and an expansion port 146, which may have the functionality, functional components (and for connecting to devices, such as power line parameter sensor device 115) as previously described above with regard of the backhaul device 138. The access device 139 also may include a gigabit Ethernet (gig-E) port 156. The gig-E port 156 maintains a connection using a gigabit Ethernet protocol as described above for the gig-E switch 146 of FIG. 8. The power parameter sensor device 115 may be connected to the access device 139 to measure and/or detect one or more parameters of the MV power or the LV power line, which, for example, may include power usage data, power line voltage data, power line current data, detection of a power outage, detection of water in a pad mount, detection of an open pad mount, detection of a street light failure, power delivered to a transformer data, power factor data (e.g., the phase angle between the voltage and current of a power line), power delivered to a downstream branch data, data of the harmonic components of a power signal, load transients data, and/or load distribution data. In addition, the access device 134 may include multiple sensor devices 115 so that parameters of multiple power lines may be measured such as a separate parameter sensor device 115 on each of three MV power line conductors and a separate parameter sensor device 115 (e.g., for measuring voltage and/or current) on each of two energized LV power line conductors and one on each neutral conductor. One skilled in the art will appreciate that other types of utility data also may be gathered. The sensor devices 115 described herein may be co-located with the power line communication device with which the sensor device 115 communicates or may be displaced from such device (e.g., at the next utility pole or transformer).

The Gig-E port 156 may maintain an Ethernet connection for communicating with various devices over optical fiber, coaxial cable or other wired medium. For example, a communication link 157 may be maintained between the access device 139 and another device through the gig-E port 156. For example, the gig-E port 156 may provide a connection to user devices 130, sensor devices (as described above with regard to the expansion port 146, such as to power line parameter sensor device 115), or a cell station 155.

Communications may be received at the access device 139 through the MV interface 140, LV interface 144, expansion port 146 or gig-E port 156. Communications may enter the access device 139 from the MV power lines 110 through the MV interface 140, and then may be routed to the LV interface 142, expansion port 146 or gig-E port 156. Communications may enter the access device 139 from the LV power lines 114 through the LV interface 144, and then may be routed to the MV interface 140, the expansion port 146, or the gig-E port 156. Communications may enter the access device 139 from the expansion port 146, and then may routed to the MV interface 140, the LV interface 144, or the gig-E port 156. Communications may enter the access device 139 via the gig-E port 156, and then may be routed to the MV interface 140, the LV interface 144, or the expansion port 146. The controller 142 controls communications through the access device 139. Accordingly, the access device 139 receives data from the MV interface 140, LV interface 144, the expansion port 146, or the gig-E port 156 and may route the data to the MV interface 140, LV interface 144, expansion port 146, or gig-E port 156 under the direction of the controller 142. In one example embodiment, the access node 134 may be coupled to a backhaul node 132 via a wired medium coupled to Gig-E port 156 while in another embodiment, the access node is coupled to the backhaul node 132 via an MV power line (via MV interface 140). In yet another embodiment, the access node 134 may be coupled to a backhaul node 132 via a wireless link (via expansion port 146 or Gig-E port 156). In addition, the controller may include program code that is executable to control the operation of the device 139 and to process the measured parameter data to, for example, convert the measured data to current, voltage, or power factor data.

Thus, the VM 300 may be integrated into access node 134 or backhaul node of this power line communication system. The threshold values may be received via the MV interface 140 and stored in the memory of controller 142. Controller 142 may be configured to average (or sum) the voltage data of the first and second energized conductors of the low voltage power line 114 and store the data and/or, if applicable, transmit an alert if the averaged (or summed) data is beyond a threshold value.

### Other Devices:

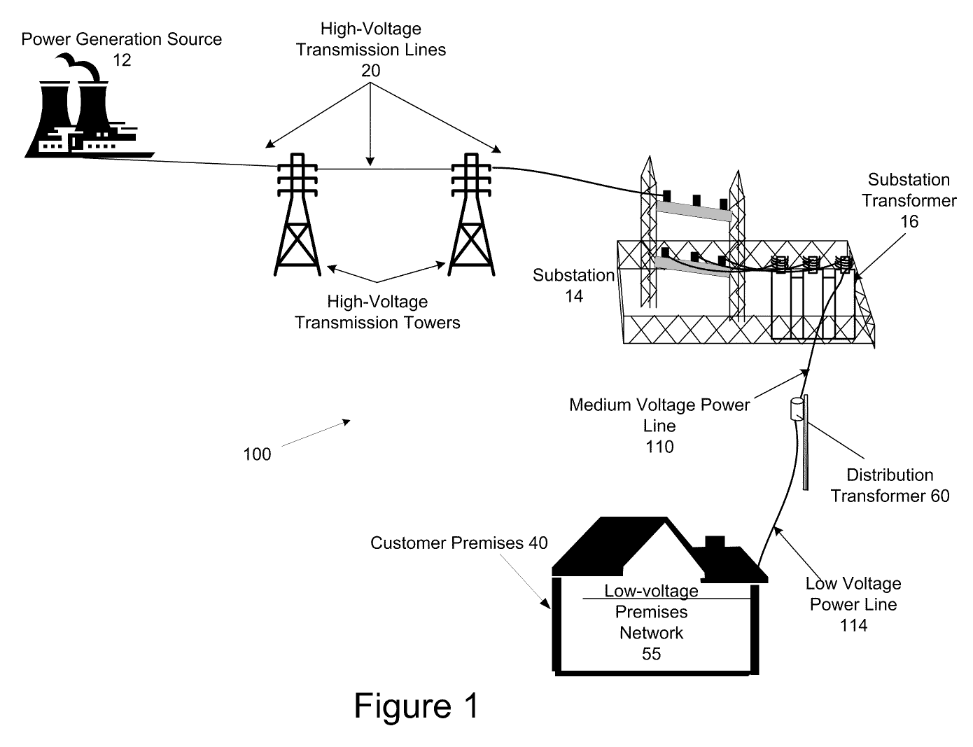

Another communication device is a repeater (e.g., indoor, outdoor, low voltage (LVR) and/or medium voltage) which may form part of a repeater node 135 (see FIG. 1). A repeater serves to extend the communication range of other communication elements (e.g., access devices, backhaul devices, and other nodes). The repeater may be coupled to power lines (e.g., MV power line; LV power line) and other communication media (e.g., fiber optical cable, coaxial cable, T-1 line or wireless medium). Note that in some embodiments, a repeater node 135 may also include a device for providing communications to a user device 130 (and thus also serve as an access node 134).

In various embodiments a user device 130 is coupled to an access node 134 using a modem. For a power line medium, a power line modem 136 is used. For a wireless medium, a wireless modem is used. For a coaxial cable, a cable modem is may be used. For a twisted pair, a DSL modem may be used. The specific type of modem depends on the type of medium linking the access node 134 and user device 130.

In addition, the PLCS may include intelligent power meters (which may form the VM 300), which, in addition to measuring power usage, may include a parameter sensor device 115 and also have communication capabilities (a controller coupled to a modem coupled to the LV power line) for communicating the measured parameter data to the access node 134. Detailed descriptions of some examples of such power meter modules are provided in U.S. patent application Ser. No. 11/341,646, filed on Jan. 30, 2006 entitled, “Power Line Communications Module and Method,” which is hereby incorporated herein by reference in it entirety. Some examples of a sensor devices coil are described in U.S. Pat. No. 6,313,623 issued on Nov. 6, 2001 for “High Precision Rogowski Coil,” which is incorporated herein by reference in its entirety.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of regulating the voltage of the power supplied to a plurality of power customers via a power distribution system that includes low voltage power lines and medium voltage power lines, comprising:
measuring the voltage of a plurality of low voltage power lines at a plurality locations in the power distribution system with a plurality of voltage monitoring devices;
with the plurality of voltage monitoring devices, transmitting voltage data in real time to a remote computer system;
receiving, with the computer system, the real time voltage data of the voltage measured from the voltage monitoring devices;
comparing, with the computer system, the real time voltage data with a first threshold value; and
if the real time voltage data is beyond the first threshold value, transmitting with the computer system a first voltage adjustment instruction to a voltage control device configured to adjust the voltage supplied to a low voltage power line.

2. The method according to claim 1, wherein at least some of the voltage monitoring devices are co-located with a distribution transformer.

3. The method according to claim 1, wherein at least some of the voltage monitoring devices comprise an electric power meter.

4. The method according to claim 1, wherein the voltage control device comprises a load tap changer.

5. The method according to claim 1, wherein the voltage control device comprises a substation.

6. The method according to claim 1, wherein the voltage control device comprises a capacitor bank.

7. The method according to claim 1, further comprising with the computer system:
waiting a predetermined time period for a notification from a voltage monitoring device; and
if a notification is not received with the predetermined time period, transmitting a second voltage adjustment instruction to a voltage control device configured to adjust the voltage supplied to a low voltage power line.

8. A system for regulating the voltage of the power supplied to a plurality of power customers via a power distribution system that includes low voltage power lines and medium voltage power lines, comprising:
a voltage monitoring device configured to measure the voltage of a first low voltage power line to provide voltage data;
wherein said voltage monitoring device is configured to compare the measured voltage with a first threshold value;
wherein said voltage monitoring device is configured to transmit an alert to a remote computer system if the measured voltage is beyond the first threshold value;
wherein said voltage monitoring device is configured transmit voltage data to the remote computer system;
wherein said remote computer system is configured to receive the alert and voltage data of the voltage measured from the voltage monitoring device; and
in response to receiving the alert, said remote computer system being configured to transmit a first voltage adjustment instruction to a voltage control device that is configured to adjust the voltage supplied to a medium voltage power line connected, via a distribution transformer, to the first low voltage power line if the real time voltage data is beyond the first threshold value.

9. The system according to claim 1, wherein said remote computer system is configured to wait a predetermined time period for a notification and, if a notification is not received during the predetermined time period, to transmit a second voltage adjustment instruction to a voltage control device.

10. A method of controlling the voltage of the power delivered by a power distribution system that includes low voltage power lines and a medium voltage power lines, comprising:
(a) monitoring the voltage of one or more low voltage power lines with one or more voltage monitoring devices;
(b) decrementing the voltage supplied to the medium voltage power line;
(c) with a computer system, waiting a first predetermined time period for a voltage alert is received from the one or more voltage monitoring device; and
(d) if no voltage alert is received by the computer system during the first predetermined time period, repeating steps (b) and (c) until a low voltage alert is received.

11. The method according to claim 10, further comprising with the computer system:
(e) upon receipt of a voltage alert, outputting an instruction to adjust the voltage supplied to the medium voltage power line;
(f) waiting a second predetermined time period for a notification; and
(g) if no notification is received during the second predetermined time period, repeating steps (e) and (f).

12. The method according to claim 10, wherein at least some of the plurality of the voltage monitoring devices comprise electric power meters.

13. The method according to claim 10, wherein at least some of the plurality of voltage monitoring devices are co-located with a distribution transformer and measure the voltage of an external low voltage power line.

14. A method of controlling the voltage of the power delivered by a power distribution system that includes low voltage power lines and a medium voltage power lines, comprising:
measuring a voltage of a low voltage power line to provide voltage data with a device;
determining whether the measured voltage is beyond a threshold value;
transmitting at least some voltage data to a remote computer system from the device in real time; and
outputting a voltage adjustment instruction with the remote computer system to adjust a voltage supplied to a medium voltage power line if the voltage is beyond a threshold voltage.

15. The method according to claim 14, further comprising:
with the remote computer, processing at least some received voltage data to determine whether to:
increase a voltage supplied by the substation; or
decrease a voltage supplied by the substation.

16. The method according to claim 14, wherein said measuring a voltage comprises:
measuring a voltage on a first energized low voltage conductor referenced to ground; and
measuring a voltage on a second energized low voltage conductor referenced to ground.

17. The method according to claim 16, further comprising averaging the measurements of the first and second energized low voltage conductors to provide an average voltage and wherein said determining comprises:
comparing the average voltage with a threshold voltage value.

18. The method according to claim 16, further comprising adding the measurements of the first and second energized low voltage conductors to provide a combined voltage and wherein said determining comprises:
comparing the combined voltage with a threshold voltage value.

19. The method according to claim 14, wherein said measuring a voltage comprises measuring a voltage between a first energized low voltage conductor and a second energized low voltage conductor; and wherein said determining comprises:
comparing the measured voltage with a threshold voltage value.

20. The method according to claim 14, wherein said outputting comprises transmitting a voltage adjustment instruction from the remote computer to a load tap changer.

21. The method according to claim 14, wherein the voltage data is transmitted to the remote computer via a data path that includes a mobile telephone network.

22. The method according to claim 14, wherein said transmitting is performed after said comparing and in response to determining that the measured voltage is beyond the threshold value.

23. The method according to claim 14, wherein said transmitting comprises periodically transmitting the voltage data.

24. The method according to claim 14, wherein the transmitted voltage data comprises an alert that the measured voltage is beyond a threshold value.

25. The method according to claim 14, further comprising with the remote computer:
identifying utility equipment for adjusting the voltage based on information received from the device transmitting the voltage data.

26. The method according to claim 25, wherein said identifying comprises:
determining a location of the device based on information transmitted by the device; and
identifying the substation based on the location of the device.

27. The method according to claim 14, with the remote computer system, transmitting a request for voltage data to the device and said transmitting at least some voltage data is performed in response to receiving the request.

28. A method of controlling the voltage of the power delivered by a power distribution system that includes low voltage power lines and a medium voltage power lines, comprising:
with each of a plurality of voltage monitoring devices, measuring a voltage of the a different low voltage power line;
wherein a first voltage monitoring device measures a voltage of a first low voltage power line;
with each of a plurality of voltage monitoring devices, comparing the measured voltage with a threshold value;
with the first voltage monitoring device, determining that the measured voltage is beyond the threshold value;
with the first voltage monitoring device, transmitting the voltage data to a remote computer system; and
outputting from the remote computer system a voltage adjustment instruction to a voltage control device configured to adjust the voltage supplied to a medium voltage power line that is connected, via a distribution transformer, to the first low voltage power line.

29. The method according to claim 28, further comprising:
receiving voltage data from a multitude of the voltage monitoring devices; and
determining whether voltage data received from each voltage monitoring device is beyond a threshold value.

30. The method according to claim 28, further comprising at the remote computer system:
identifying a substation that supplies power to the medium voltage power line connected to the first low voltage power line; and
wherein the voltage control device comprises the identified substation.

31. The method according to claim 28, further comprising:
with the remote computer system, transmitting data of one or more threshold voltages to each of the voltage monitoring devices; and
with each of the voltage monitoring devices:
receiving the one or more threshold values; and
storing the one or more threshold values in memory;
